(19) United States
(12) Patent Application Publication
(10) Pub. No.: US 2014/0227439 A1
(43) Pub. Date: Aug. 14, 2014

(54) Simplified paint applicator and related methods

(71) Applicant: Robert E. Porter, Topanga, CA (US)

(72) Inventor: Robert E. Porter, Topanga, CA (US)

(21) Appl. No.: 14/259,134

(22) Filed: Apr. 22, 2014

Related U.S. Application Data
(63) Continuation-in-part of application No. 13/145,988, filed on Sep. 13, 2011, now Pat. No. 8,763,554.
(60) Provisional application No. 61/206,033, filed on Jan. 27, 2009.
(60) Provisional application No. 61/815,176, filed on Apr. 23, 2013.

(51) Int. Cl. B05B 13/06

(52) U.S. Cl. CPC B05B 13/0636
USPC 427/236; 239/264; 239/226

(57) ABSTRACT

Generally disclosed are devices and methods that might be used to paint the inside of golf hole. To this end, in an exemplary embodiment of the present invention, a paint spraying device 1000 includes: a masking frame 1100; a paint can port 1200 and nozzle housing 1300 assembly that is coaxially and pivotally mounted to the frame 1100; and, a trigger 1400 that is configured to activate the paint release mechanism of an aerosol spray paint can whenever the paint can port 1200 and nozzle housing 1300 assembly are rotated relative to the frame 1100.

### CROSS-REFERENCE TO RELATED APPLICATIONS

This application claims the priority and benefit of U.S. Prov. App. Ser. No 61/815,176 (filed Apr. 23, 2013) entitled “Simplified Paint Applicator” This application is also a continuation-in-part of U.S. patent application Ser. No. 13/145,988 (§371(c)(1),(2),(4) date: Sep. 13, 2011) which claims the priority and benefit of PCT App. Ser. No US210/22252 (filed Jan. 27, 2010) and U.S. Prov. App. Ser. No. 61/206,033 (Filed Jan. 27, 2009). Said patent documents are hereby incorporated by reference in their entirety.

### STATEMENT REGARDING FEDERALLY SPONSORED RESEARCH OR DEVELOPMENT

Not applicable.

### BACKGROUND OF THE INVENTION

1. Field of Invention

This invention relates to the painting of the inside of a recessed cavity, specifically a golf hole.

2. Background of the Invention

Golfers and golf course superintendents usually prefer that a hole, i.e., target of a golf shot, on a golf course be colored white so the hole is easily identifiable on the green. A golf cup, which lines a hole, is white but set into the golf hole at least one inch below the surface of the green so that an inch of brown soil, instead of the white cup, is the only visible target for golfers on the green. To provide the desired color contrast, the soil is often painted white. A method currently used for coloring the soil is to paint the soil. A paint brush is problematic for painting soil since its bristles might clog with dirt, sand, or other debris. Spray paint, though better than a paint brush, is also problematic for painting soil around a golf hole because it can adversely affect the grass of the green or potentially spray onto or drip into the cup.

Spray paint can be applied with a masking apparatus to avoid contacting the grass or golf cup with paint when coloring the soil of a golf hole. Currently, devices exist which mask the grass and cup while a spray canister rotates relative to the golf hole to spray the soil. These devices require the user to activate the spray canister and rotate it relative to the golf hole. Activation and rotation of these devices require the simultaneous application of force in multiple directions. These devices are difficult to operate and lead to irregular spray patterns or excess paint build-up, leaving an unattractive, uneven residue in the golf hole. Furthermore, sometimes these devices include multiple supports in the line of spray paint which prevent paint from being sprayed onto the soil behind them. To overcome this limitation, the entire device must be rotated and paint reapplied after a first paint coat to achieve full coverage of paint around the hole.

Another solution does not include paint but rather a plastic sleeve which sits on top of the cup and is colored white. This sleeve can slide upward upon removal of the flag pole and thus prevent golf bails from rolling into the cup. These sleeves do not comply with the common rules of golf.

### SUMMARY OF THE INVENTION

In view of the foregoing, it is an object of this specification to provide a paint spraying device that is easy to use. It is also an object of this disclosure to provide a paint spraying device that is connected to a paint source that dispenses paint without a downward force when the paint source is rotated. A further object of this document is to provide a paint spraying device that does not require the application of force in multiple directions. Another object of this disclosure is to provide a spraying solution that simultaneously sprays in multiple directions.

Yet another object of this description is to provide a paint spraying device that does not apply unwanted paint to the golf cup or to the green. Other objects of this invention include: the creation of a paint spraying device that adjusts to golf cups set to various depths; the creation of a paint spraying device that is compatible with various types of golf cups; the creation of a paint spraying device that quickly and easily turns the soil above the golf cup white.

These and other objects of this specification are achieved by creating a paint spraying device that utilizes at least one nozzle which sprays paint when activated. In a preferred embodiment, the activation of the nozzle or nozzles requires a turn of the paint source and/or the nozzle housing. The nozzle housing may be bordered by a putting green mask that prevents overspray onto the putting green, while a golf cup mask may be used to prevent paint being applied to the golf cup. Additionally, the paint spraying device may provide a paint spray that can coat the soil in a golf hole located anywhere on a golf course with a half-turn of the paint can port and sprayer assembly.

Various embodiments of the systems and methods described herein are related to painting and more particularly, to systems and methods that might be used to paint the inside of a recessed cavity, for example, a golf hole. To this end, in an exemplary embodiment of the present disclosure is a paint spraying device that includes: a masking frame; a paint can port and nozzle housing assembly that is coaxially and pivotally mounted to the frame; and, a trigger that is configured to activate the paint release mechanism of an aerosol spray paint can whenever the paint can port and nozzle housing assembly are rotated relative to the frame. An example of the paint spraying device would feature the trigger being a lever that pivots on the paint can port whenever the paint can port and nozzle housing assembly are rotated relative to the frame. In this embodiment, the rotating of the paint can port and nozzle housing assembly simultaneously pivots the lever to offset the actuator of the spray paint can releasing paint into the nozzle housing and out of at least one nozzle coupled thereto. In a preferred embodiment, one end of the trigger can be connected to the disc that spins relative to the frame on the same axis as the paint can port and nozzle housing assembly, but which spins independently of said assembly. By providing a relative rotational resistance between the disc and the paint can port and nozzle housing assembly, the force required to spin the disc can provide the force needed to pivot the trigger mechanism on the paint can port. The resistance on the trigger could also be provided by a spring or other means, or a brake composed of metal, plastic, rubber, or other material.

Other objectives and desires may become apparent to one of skill in the art after reading the below disclosure and viewing the associated figures.

### BRIEF DESCRIPTION OF THE FIGURES

The manner in which these objectives and other desirable characteristics can be obtained is explained in the following description and attached figures in which:

FIG. 1 is a perspective view of a spraying apparatus;

FIG. 1A is a contextual view of the spraying apparatus in a golf hole;

FIG. 2 is a top view of the spraying apparatus of FIG. 1;

FIG. 3 is a bottom view of the spraying apparatus of FIG. 1;

FIG. 4 is a side view of the spraying apparatus of FIG. 1;

FIG. 5 is a cross section of the spraying apparatus of FIG. 1;

FIG. 6 is an environmental view of the spraying apparatus of FIG. 1;

FIG. 7A through 7D are diagram of operation for the spraying apparatus of FIG. 1; and,

FIG. 8 is a flow chart of the process of operation of the spraying apparatus of FIG. 1.

It is to be noted, however, that the appended figures illustrate only typical embodiments of the disclosed assemblies, and therefore, are not to be considered limiting of their scope, for the disclosed assemblies may admit to other equally effective embodiments that will be appreciated by those reasonably skilled in the relevant arts. Also, figures are not necessarily made to scale.

### DETAILED DESCRIPTION OF PREFERRED EMBODIMENTS

Generally disclosed are devices and methods that might be used to paint the inside of a golf hole. To this end, in an exemplary embodiment of the present invention, a paint spraying device 1000 includes: a frame 1100; a paint can port 1200 and nozzle housing 1300 assembly that is coaxially and pivotally mounted to the frame 1100; and, a trigger 1400 that is configured to activate the paint release mechanism of an aerosol spray paint can whenever the paint can port 1200 and nozzle housing 1300 assembly are rotated relative to the frame 1100. The specifics of this preferred embodiment are disclosed with reference to the figures.

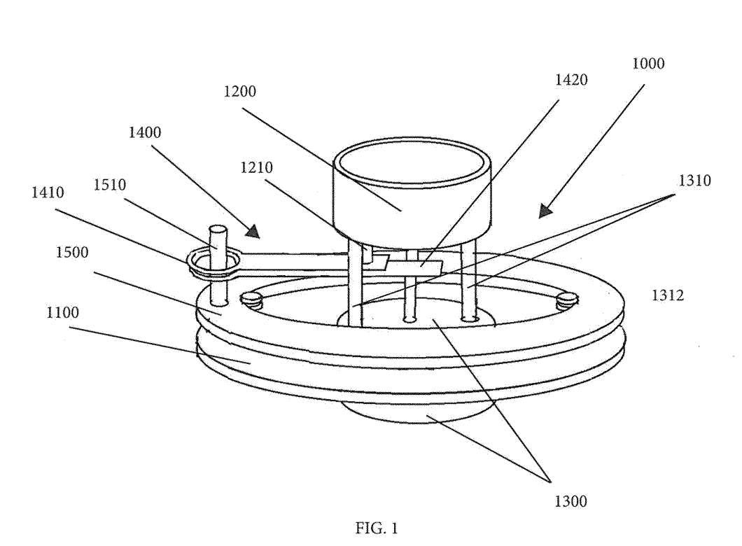

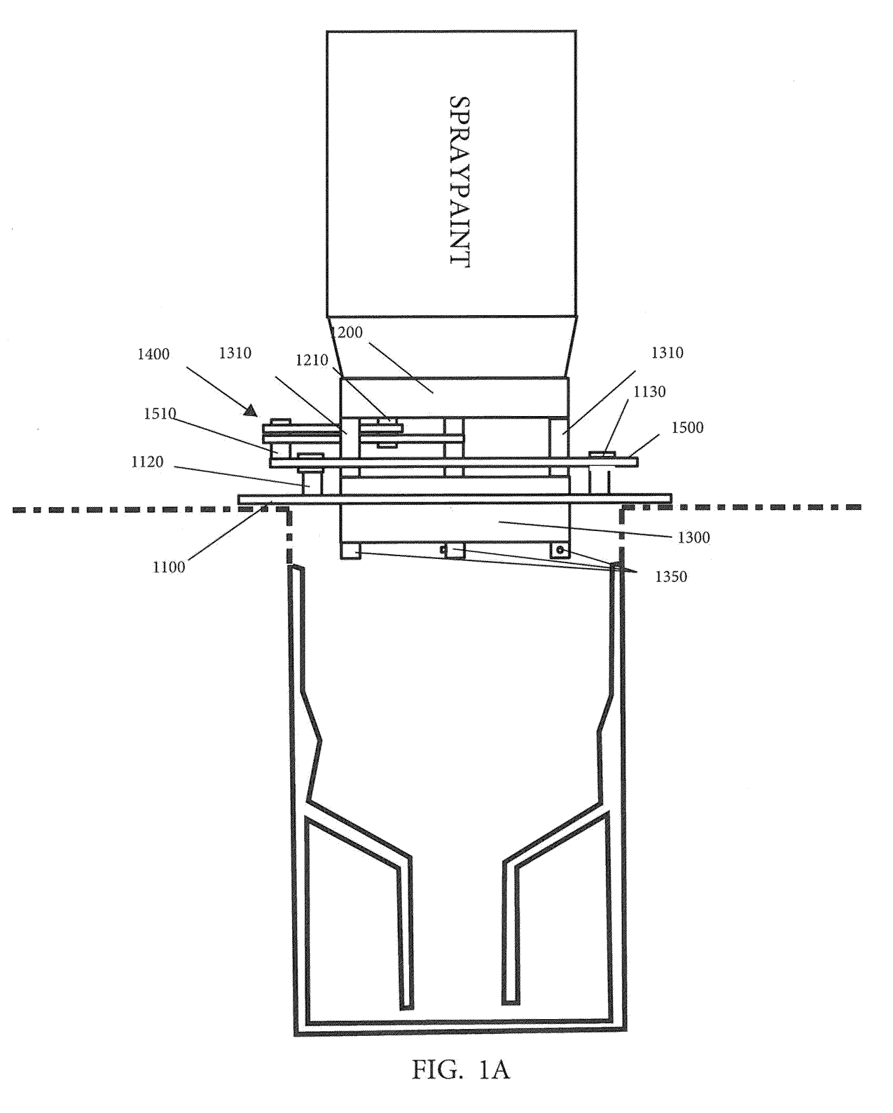

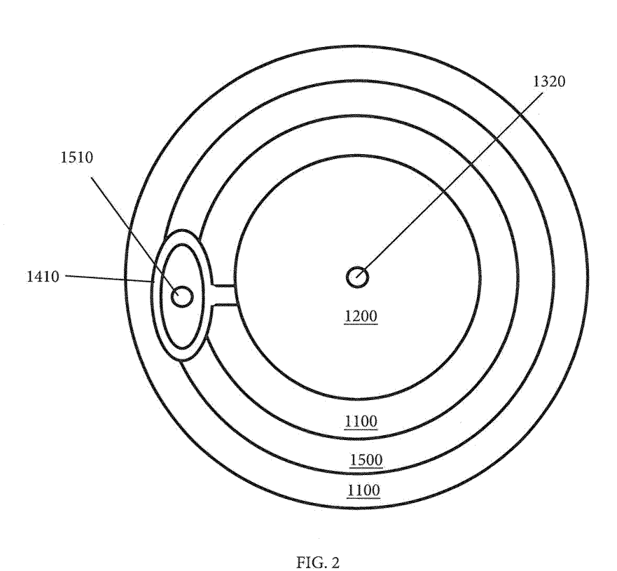

FIG. 1 is a perspective view of a spraying device 1000. FIGS. 2 through 4 respectively illustrate top, bottom, and side views of the spraying device 1000. As shown, the device 1000 is generally defined by a masking frame 1100 that pivotally and coaxially supports a paint can port 1200, a nozzle housing 1300, and an activation disk 1500. For context, FIG. IA is provided wherein the masking frame is centered on a golf hole, a spray can is installed in the spray can port 1200 while the nozzle housing is directed into the housing with the nozzles directed to exposed soil.

Referring to FIGS. 1 through 4, in the preferred embodiment, the paint can port 1200 and nozzle housing 1300 are vertically assembled and are mechanically coupled via coupling rods 1310 so that the paint can port 1200 and nozzle housing 1300 are simultaneously rotatable within the frame 1100. Suitably, the coupling rods 1310 are extendable for adjusting the distance the nozzle housing 1300 is extended below the frame 1100. The paint can port 1200 and nozzle housing 1300 are rotatably coupled to the frame via a track 1110 at the interface of the frame 1100 and nozzle housing 1300 (see FIG. 3). As shown, paint shaft 1320 provides fluid communication between the paint can port 1200 and the nozzles 1350 at the bottom of the nozzle housing

Still referring to FIGS. 1 through 4, an activation disk 1500 with an activation rod 1510 is positioned coaxially around the paint can port 1200 and nozzle housing 1300 assembly. The disk 1500 sits within a track 1130 atop two swivelable bearings 1120 that rise up from the frame 1100. Within said track 1130, the disk 1500 is rotatable relative to the frame 1100 independent of the rotation of the paint can port 1200 and nozzle housing 1300 assembly. Finally, a trigger 1400, is pivotally mounted to the paint can port 1200 via pivot rod 1210 and extends: (a) to a loop end 1410 that is positioned around the activation rod 1410; and (b) a lever end that extends toward the center of the paint can port 1200 and nozzle housing 1300 assembly. As discussed in greater detail below, rotation of the paint can port 1200 and nozzle housing assembly relative to the frame 1100 causes the loop end 1400 of the trigger to interact with the activation rod 1510 so that the trigger pivots whereby the lever end interacts with the paint shaft 1320 to activate a spray can installed on the paint can port. In operation, the masking frame may act as a paint mask for the green.

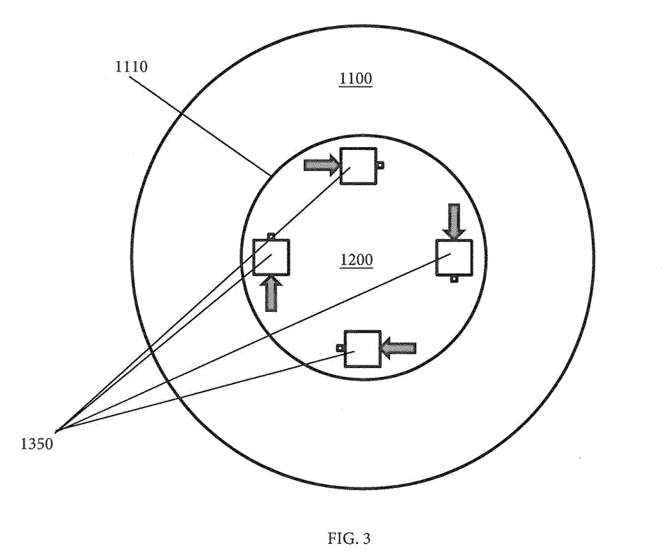

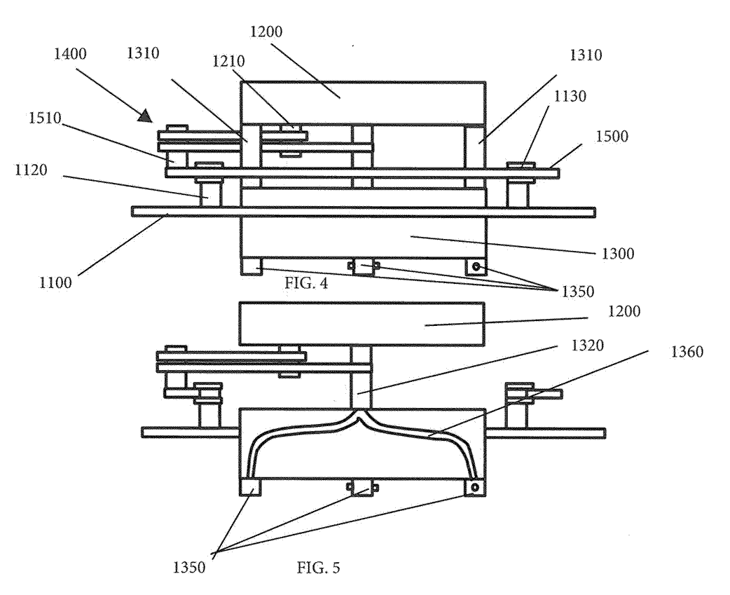

FIG. 5 is a cross section of the spraying apparatus of FIG. 1. As disclosed in detail above, the paint shaft 1320 is in fluid communication with the nozzles 1350 of the nozzle housing 1300. As shown, the nozzle housing 1300 features piping 1360 so that paint may be delivered through the paint shaft for discharge at the nozzles whenever the trigger interacts with the paint shaft to cause spray activation of a paint can installed in the paint can port so that the activation nozzle of the paint can is directed into the paint shaft 1320. FIG. 6 is a depiction of paint being discharged from the nozzles of the nozzle housing.

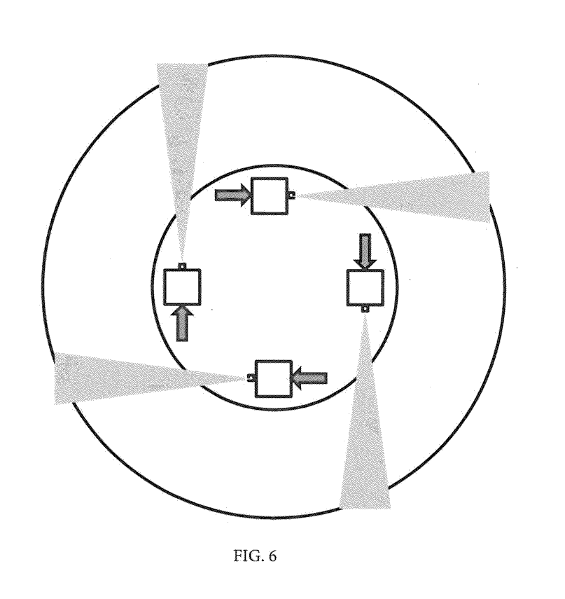

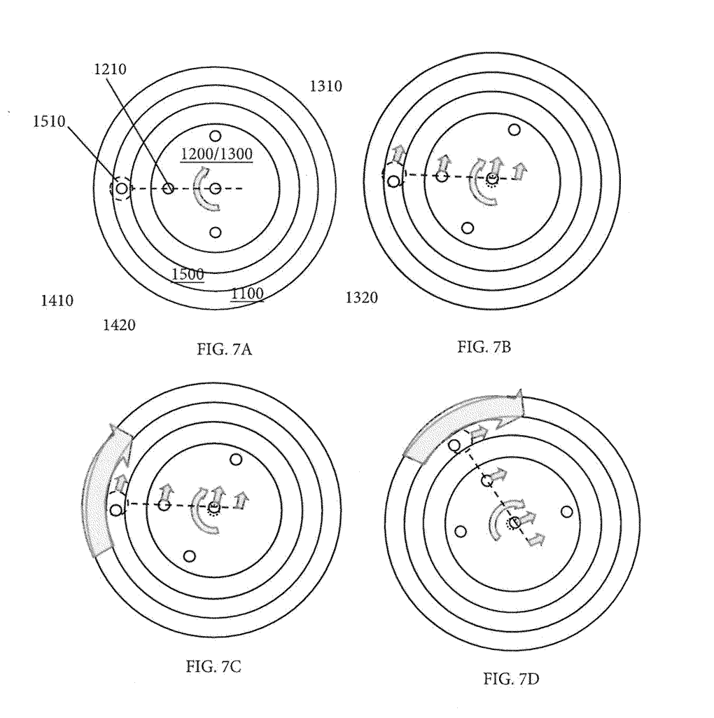

FIG. 7A through 7D are diagram of operation for the spraying apparatus of FIG. 1. Beginning with FIG. 7A, the frame 1100 of the device may be centered over a golf hole and the paint can port and housing assembly 1200/1300 rotated relative to the frame 1100. Continuing to FIG. 78, as the assembly 1200/1300 rotates, the loop end 1410 of the lever 1400 will interact with the activation rod 1510. FIG. 7B further shows that, upon interaction of the lever 1400 with the activation rod 1510, the trigger 1400 will pivot on the pivot rod 1210 with continued rotation of the assembly 1200/1300. As shown, pivoting the trigger 1400 brings the lever end 1420 of the trigger 1400 into contact with the paint shaft 1320 and deflects the activation nozzle of an installed paint can. FIG. 7C shows that further rotation of the assembly causes rotation of the activation disk 1500. Suitably, the disk rotates with some resistance so that the trigger continues to interact with the shaft 1320 to activate paint spray. However, the resistance should not be too great since the trigger lever could, with enough force, harm the shaft 1320. Finally, the spraying of paint can be stopped via stopping rotation of the assembly 1200/1300. A flow chart of this process is provided as FIG. 8.

While various embodiments of the method and apparatus have been described above, it should be understood that they have been presented by way of example only, and not of limitation. Likewise, the various diagrams might depict an example of an architectural or other configuration for the disclosed method and apparatus, which is done to aid in understanding the features and functionality that might be included in the method and apparatus. The disclosed method and apparatus is not restricted to the illustrated example architectures or configurations, but the desired features might be implemented using a variety of alternative architectures and configurations. Indeed, it will be apparent to one of skill in the art how alternative functional, logical or physical partitioning and configurations might be implemented to implement the desired features of the disclosed method and apparatus. Also, a multitude of different constituent module names other than those depicted herein might be applied to the various partitions. Additionally, with regard to flow diagrams operational descriptions and method claims, the order in which the steps are presented herein shall not mandate that various embodiments be implemented to perform the recited functionality in the same order unless the context dictates otherwise.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to e skilled artisan now or at any time in the future.

The presence of broadening words and phrases such as “one or more,” “at least,” “but not limited to” or other like phrases in some instances shah not be read to mean that the narrower case is intended or required in instances where such broadening phrases might be absent. The use of the term “module” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

I claim:

1. A paint spraying device comprising:
a frame;
a nozzle housing that is rotatably mounted on a frame and that is in fluid communication with a paint source; and,
wherein rotating the nozzle housing relative to the frame causes paint within the paint source to be emitted from the nozzle housing.

2. The paint spraying device of claim 1 further comprising:
a port coupled to the paint source, said paint source having a paint release mechanism; and,
a trigger that is pivotally coupled to the nozzle housing so that said trigger pivots to interact with the paint release mechanism of the paint source whenever the nozzle housing and port are rotated relative to the frame.

3. The paint spraying device of claim 2 further comprising:
Wherein the nozzle housing features piping for at least one nozzle, wherein said nozzle housing is mechanically coupled to the port and rotatably coupled to the frame so that the port and nozzle housing rotate together relative to the frame; and,
a paint shaft for fluidly connecting the port and said piping.

4. The paint spraying device of claim 3 further comprising:
a port coupled to the paint source, said paint source having a paint release mechanism;
a nozzle housing with piping for at least one nozzle, wherein said nozzle housing is mechanically coupled to the port and rotatably coupled to the frame so that the port and nozzle housing rotate together relative to the frame;
a paint shaft for fluidly connecting the port and said piping;
an activation disk with an activation rod, said activation rod rotatably mounted to the frame;
wherein said activation disk rotates independently from the nozzle housing and port;
wherein said activation disk rotates relative to the frame with a greater resistance to rotation than the rotation of the nozzle housing relative to the frame;
a trigger, that is pivotally coupled to the nozzle housing so that said trigger pivots to interact with the paint release mechanism of the paint source whenever the nozzle housing and port are rotated relative to the frame;
wherein said trigger interacts with the activation rod to cause synchronized rotation of the activation disk and nozzle housing so that said greater resistance to rotation maintains interaction of the trigger and the paint release mechanism of the paint source so that paint is delivered through the paint shaft and piping to be released at the nozzle.

5. The paint spraying device of claim 4 further comprising:
an activation disk with an activation rod, said activation rod rotatably mounted to the frame;
wherein said activation disk rotates independently from the nozzle housing and port;
wherein said activation disk rotates relative to the frame with a greater resistance to rotation than the rotation of the nozzle housing relative to the frame; and,
wherein said trigger interacts with the activation rod to cause synchronized rotation of the activation disk and nozzle housing so that said greater resistance to rotation maintains interaction of the trigger and the paint release mechanism of the paint source so that paint is delivered through the paint shaft and piping to be released at the nozzle.

6. The paint spraying device of claim 1 wherein the paint source is a spray paint can.

7. The paint spraying device of claim 5 wherein the trigger is further defined by a loop end.

8. The paint spraying device of claim 7 wherein the activation rod is disposed within the loop end of the trigger.

9. The paint spraying device of claim 8 wherein said frame coaxially supports said port, nozzle housing and activation disk.

10. The paint spraying device of claim 9 wherein said port and nozzle housing are vertically assembled and coupled.

11. The paint spraying device of claim 10 wherein said port and nozzle housing are simultaneously rotatable within the frame.

12. The paint spraying device of claim 11 wherein said port and nozzle housing are rotatably coupled to the frame via a track.

13. The paint spraying device of claim 10 wherein said trigger is pivotally mounted to the paint can port via a pivot rod.

14. The paint spraying device of claim 11 wherein the rotation of the paint can port and nozzle housing relative to the frame causes the loop end of the trigger to interact with an activation rod,
wherein the trigger pivots whereby the loop end interacts with the activation rod the paint release mechanism of the paint source.

15. The paint spraying device of claim 12 wherein said paint shaft is in communication with at least one nozzle,
wherein said piping delivers paint to at least one nozzle when the trigger is activated.

16. A method of painting by:
obtaining a paint applying device with a paint source; and,
initiating a rotational movement wherein paint from the paint source is applied to a surface when the rotational movement causes the release of paint from the paint source.

17. The method of claim 16 wherein:
the paint applying device composed of a frame, a nozzle housing, a paint source with a paint release mechanism and a trigger; and,
the step of initiating a rotational movement involves (a) rotating the nozzle housing relative to the frame, and (b) pivoting a trigger so that it interacts with the paint release mechanism of the paint source to release paint.

18. A paint applying device with a paint source wherein paint from the paint source is applied to a surface when a rotational movement causes the release of paint from the paint source.
